(19) United States
(12) Patent Application Publication
(10) Pub. No.: US 2013/0329687 A1
(43) Pub. Date: Dec. 12, 2013

(54) RADIO BASE STATION AND COMMUNICATION CONTROL METHOD

(71) Applicant: Masahiro Yagi, Kawasaki-shi (JP)

(72) Inventor: Masahiro Yagi, Kawasaki-shi (JP)

(73) Assignee: KYOCERA CORPORATION, Kyoto (JP)

(21) Appl. No.: 14/000,842

(22) PCT Filed: Feb. 23, 2012
(86) PCT No.: PCT/JP2012/054443

§ 371 Date: Aug. 21, 2013

(30) Foreign Application Priority Data
Feb. 25, 2011 (JP) 2011-040350
Feb. 25, 2011 (JP) 2011-040354

(51) Int. Cl. H04W 72/04

(52) U.S. Cl. CPC H04W 72/0406
USPC 370/329

(57) ABSTRACT

When the number of the serving radio terminals UE2 in the cell 3-1 is larger than the number of the SRS transmission frequency bands that are set to the transmittable frequency band, the radio base station eNB1-1 transmits RRC Connection Reconfiguration, which includes the information (the transmission stop instruction information) instructing to stop transmitting SRS, to a serving radio terminal UE2 that is regarded as having a small PF value and a low priority of SRS transmission.

### TECHNICAL FIELD

The present invention relates to a radio base station that controls a radio terminal on the basis of a reference signal from the radio terminal, and a communication control method in the radio base station.

### BACKGROUND ART

In 3GPP (Third Generation Partnership Project), in a radio communication system corresponding to LTE (Long Term Evolution) for which standards are currently being set up, a radio base station eNB assigns a radio resource in radio communication between the radio base station eNB and a radio terminal UE (for example, refer to NPL 1). Furthermore, in the radio communication system corresponding to LTE, one of FDD (Frequency Division Duplex) and TDD (Time Division Duplex) is employed in the radio communication between the radio base station eNB and the radio terminal UE.

Moreover, in an LTE (TDD-LTE) radio communication system employing the TDD, there has been discussed a feature where a radio base station eNB performs control for adaptively directing a beam (adaptive array control) toward the radio terminal UE at the time of transmitting a downlink radio signal, in order to ensure communication quality between the radio base station eNB and a radio terminal UE that is moving.

### CITATION LIST

### Non Patent Literature

NPL 1: 3GPP TS 36.211 V8.7.0 “Physical Channels and Modulation”, MAY 2009

### SUMMARY OF THE INVENTION

As a technique of calculating an antenna weight, the following technique is expected. That is, when a radio base station eNB receives a sounding reference signal SRS, which is an uplink radio signal from a radio terminal UE, the radio base station eNB assigns a downlink radio resource (a downlink resource block) of the same frequency band as that of SRS, which the radio base station eNB received last, to the radio terminal UE that is a transmission source of the last received SRS. Moreover, the radio base station eNB calculates an antenna weight for the assigned downlink resource block. Meanwhile, when another neighboring radio base station eNB receives SRS, the other neighboring radio base station eNB performs null steering, and calculates an antenna weight such that a null is directed toward the radio terminal UE that is the transmission source of the SRS.

In this case, the radio terminal UE periodically transmits SRS according to specifications. However, when many radio terminals UE connected to the radio base station eNB transmit SRSs, the SRSs may overlap (be multiplexed) in the same frequency band at the same timing. Therefore, the other neighboring radio base station eNB is not able to uniquely determine transmission sources of the SRSs, and thus not able to direct a null.

Therefore, in view of the above-described problem, it is an object of the present invention to provide a radio base station and a communication control method which allow a neighboring radio base station to perform appropriate null steering.

In order to solve the above-described problem, the present invention has a following feature. The first feature of the present invention is summarized as follows. A radio base station (eNB1-1), which controls radio terminals (radio terminal UE2-1, radio terminal UE2-2, radio terminal UE2-3, and radio terminal UE2-4) on the basis of a reference signal (SRS) from the radio terminals, comprises: a control unit (control unit 102) that transmits information (RRC Connection Reconfiguration) instructing to stop transmitting the reference signal to a first radio terminal, which is regarded as having a low priority of transmission of the reference signal, when the number of the radio terminals is larger than the number of transmission frequency bands of the reference signal.

When the number of the radio terminals is larger than the number of the transmission frequency bands of the reference signal, the radio base station transmits information instructing to stop transmitting the reference signal to a radio terminal that is regarded as having a low priority of transmission of the reference signal. Consequently, the number of radio terminals that transmit the reference signal is equal to or smaller than the number of the transmission frequency bands of the reference signal, so that the reference signal is prevented from overlapping in the same frequency band at the same timing. Thus, another neighboring radio base station is able to uniquely determine a transmission source of the reference signal, thereby enabling appropriate null steering.

The second feature of the present invention is summarized as follows. When there is a second radio terminal, which is regarded as having a lower priority of transmission of the reference signal as compared with the first radio terminal, the control unit transmits information (RRC Connection Reconfiguration) instructing to restart transmitting the reference signal to the first radio terminal.

The third feature of the present invention is summarized as follows. The radio base station comprises: a reception unit (control unit 102) that receives, from the first radio terminal, response information (RRC Connection Reconfiguration Complete) which indicates reception of information for instructing to stop transmitting the reference signal.

The fourth feature of the present invention is summarized as follows. On the basis of an index indicating a state of radio communication by the radio terminals, the control unit selects the first radio terminal having the lowest index.

The fifth feature of the present invention is summarized as follows. The control unit selects the first radio terminal on the basis of an index of a PF (Propotional Fair) scheme of each radio terminal.

The sixth feature of the present invention is summarized as follows. The control unit selects the first radio terminal by a round-robin scheme.

The seventh feature of the present invention is summarized as follows. A communication control method in a radio base station, which controls radio terminals on the basis of a reference signal from the radio terminals, comprises: a step of transmitting information instructing to stop transmitting the reference signal to a first radio terminal, which is regarded as having a low priority of transmission of the reference signal, when the number of the radio terminals is larger than the number of transmission frequency bands of the reference signal.

The eighth feature of the present invention is summarized as follows. A radio base station (eNB1-1), which controls radio terminals (radio terminal UE2-1, radio terminal UE2-2, radio terminal UE2-3, and radio terminal UE2-4) on the basis of a reference signal (SRS) from the radio terminals, comprises: a control unit (control unit 102) that arranges transmission frequency bands of the reference signal in an available frequency band, wherein the control unit arranges the transmission frequency bands of the reference signal according to bandwidths of the transmission frequency bands of the reference signal in the radio terminals.

When performing the arrangement of the transmission frequency bands of the reference signal in the available frequency band, the radio base station performs the arrangement according to the bandwidths of the transmission frequency bands of the reference signal in the radio terminals. Thus, the radio base station, for example, is able to arrange a wide transmission frequency band of the reference signal and a narrow transmission frequency band of the reference signal at positions where the available frequency band are different from one another, at a predetermined timing. Through such control, the reference signal is prevented from overlapping in the same frequency band at the same timing. Thus, another neighboring radio base station is able to uniquely determine a transmission source of the reference signal, thereby enabling appropriate null steering.

The ninth feature of the present invention is summarized as follows. The control unit performs arrangement in the available frequency band for each group of the transmission frequency bands of the reference signal having the same bandwidth.

The tenth feature of the present invention is summarized as follows. The control unit arranges the transmission frequency bands of the reference signal, which belong to different groups, at different positions in the available frequency band.

The eleventh feature of the present invention is summarized as follows. A communication control method in a radio base station, which controls radio terminals on the basis of a reference signal from the radio terminals, comprises: a control step of arranging, by the radio base station, transmission frequency bands of the reference signal in an available frequency band, wherein in the control step, the radio base station arranges the transmission frequency bands of the reference signal according to bandwidths of the transmission frequency bands of the reference signal in the radio terminals.

### BRIEF DESCRIPTION OF THE DRAWINGS

FIG. 1 is a diagram illustrating the entire schematic configuration of a radio communication system according to the embodiment of the present invention.

FIG. 2 is a diagram illustrating a format of the resource block according to the embodiment of the present invention.

FIG. 3 is a diagram illustrating a format of the frame according to the embodiment of the present invention.

FIG. 4 is a diagram illustrating the configuration of the available frequency band in radio communication between the radio base station and the radio terminal according to the embodiment of the present invention.

FIG. 5 is a configuration diagram of the radio base station according to the embodiment of the present invention.

FIG. 6 is a diagram illustrating a first example of the arrangement of the radio terminal according to the embodiment of the present invention.

FIG. 7 is a diagram illustrating a first example of setting and arranging the SRS transmission frequency bands according to the embodiment of the present invention.

FIG. 8 is a diagram illustrating a second example of the arrangement of the radio terminal according to the embodiment of the present invention.

FIG. 9 is a diagram illustrating a second example of setting and arranging the SRS transmission frequency bands according to the embodiment of the present invention.

FIG. 10 is a flowchart illustrating the first operation of the radio base station according to the embodiment of the present invention.

FIG. 11 is a flowchart illustrating the second operation of the radio base station according to the embodiment of the present invention.

FIG. 12 is a flowchart illustrating the third operation of the radio base station according to the embodiment of the present invention.

### DESCRIPTION OF THE EMBODIMENTS

Next, with reference to the drawings, the embodiment of the present invention will be described. Specifically, the description will be given in the order of (1) Configuration of radio communication system, (2) Configuration of radio base station, (3) Operation of radio base station, (4) Operation and effect, and (5) Other embodiments. In the drawings of the embodiment, the same or similar reference signs are applied to the same or similar parts.

### (1) Configuration of Radio Communication System

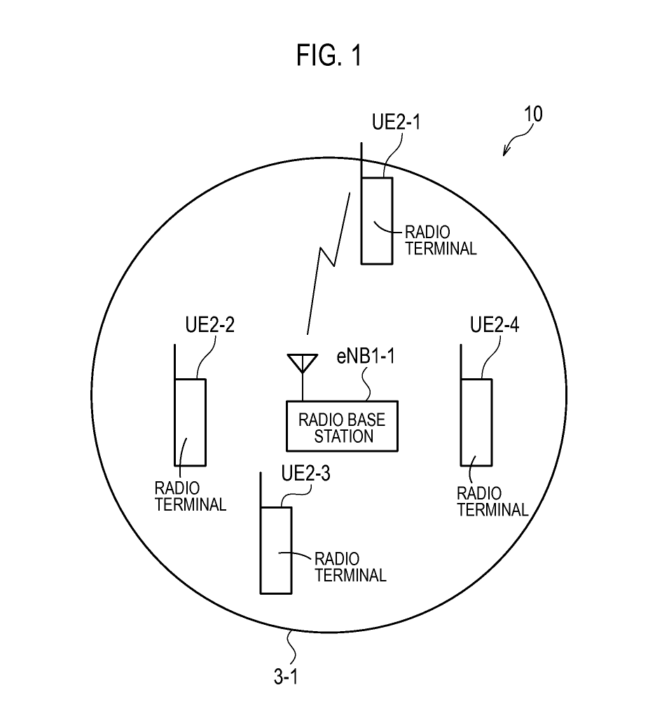

FIG. 1 is a diagram illustrating the entire schematic configuration of a radio communication system 10 according to the embodiment of the present invention.

The radio communication system 10 illustrated in FIG. 1 is a TDD-LTE radio communication system. The radio communication system 10 includes a radio base station eNB1-1, a radio terminal UE2-1, a radio terminal UE2-2, a radio terminal UE2-3, and a radio terminal UE2-4.

As illustrated in FIG. 1, the radio base station eNB1-1 constitutes E-UTRAN (Evolved-UMTS Terrestrial Radio Access Network). The radio terminal UE2-1 to the radio terminal UE2-4 exist in a cell 3-1 that is a communication available area provided by the radio base station eNB1-1.

The radio terminal UE2-1 to the radio terminal UE2-4 are terminals to which a resource block is assigned by the radio base station eNB1-1. In this case, when the radio base station eNB1-1 is set as a reference, the radio terminal UE2-1 to the radio terminal UE2-4 are serving radio terminals. Hereinafter, the radio terminal, to which the resource block is assigned by the radio base station eNB1-1, will be appropriately referred to as a serving radio terminal UE2.

Time division duplex is employed in radio communication between the radio base station eNB1-1 and the radio terminal UE2-1 to the radio terminal UE2-4, OFDMA (Orthogonal Frequency Division Multiplexing Access) is employed in downlink radio communication, and SC-FDMA (Single Carrier Frequency Division Multiple Access) is employed in uplink radio communication. Furthermore, downlink indicates a direction from the radio base station eNB1-1 to the radio terminal UE2-1 to the radio terminal UE2-4. Uplink indicates a direction from the radio terminal UE2-1 to the radio terminal UE2-4 to the radio base station eNB1-1.

The radio base station eNB1-1 assigns a resource block (RB) as a radio resource to the serving radio terminal UE2 in the cell 3-1.

The resource block includes a downlink resource block (downlink RB) to be used in the downlink radio communication and an uplink resource block (uplink RB) to be used in the uplink radio communication. A plurality of downlink resource blocks are arranged in the frequency direction and the time direction. Similarly, a plurality of uplink resource blocks are arranged in the frequency direction and the time direction.

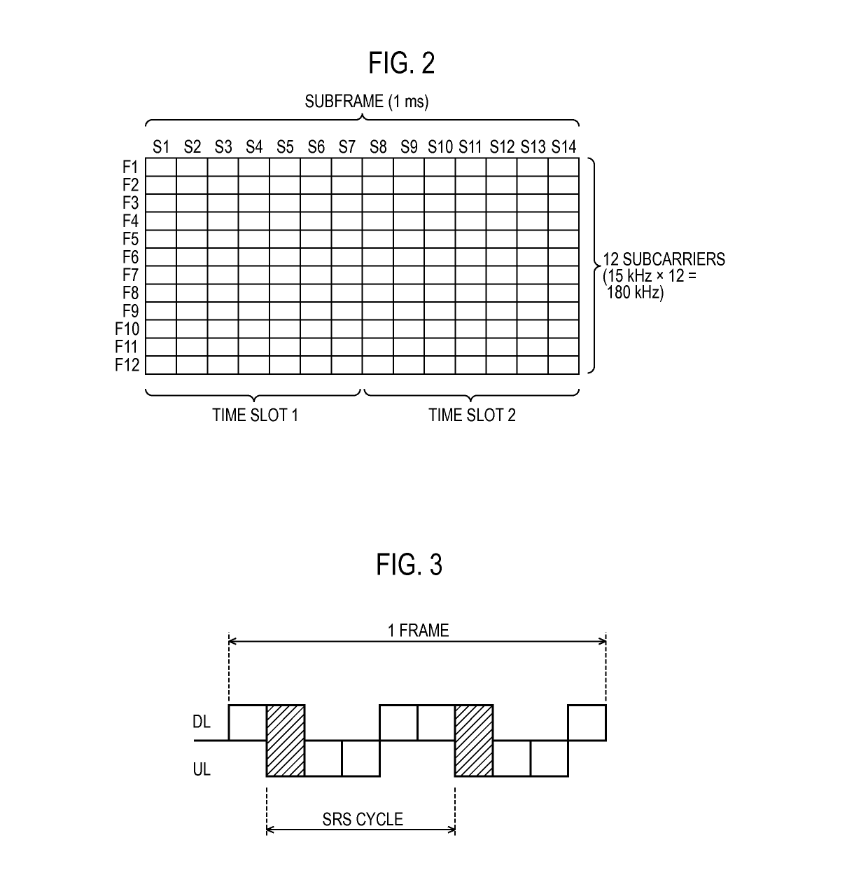

FIG. 2 is a diagram illustrating a format of the resource block.

As illustrated in FIG. 2, the resource block is configured by one subframe having a time length of 1 [ms] in the time direction. The subframe includes a time zone 51 to a time zone S14. Among the time zone 51 to the time zone S14, the time zone 51 to the time zone S7 constitute a first half time slot (time slot 1) and the time zone S8 to the time zone S14 constitute a second half time slot (time slot 2).

As illustrated in FIG. 2, the resource block has a frequency width of 180 [kHz] in the frequency direction. Furthermore, the resource block includes 12 subcarriers F1 to F12 having a frequency width of 15 [kHz].

Furthermore, in the time direction, a plurality of subframes constitute one frame. FIG. 3 is a diagram illustrating a format of the frame. The frame illustrated in FIG. 3 is configured by 10 subframes. The frame includes the 10 subframes in the sequence of a subframe of a downlink resource block, a subframe (a special subframe: SSF) of both of a downlink resource block and an uplink resource block, a subframe of an uplink resource block, a subframe of an uplink resource block, a subframe of a downlink resource block, a subframe of a downlink resource block, a special subframe, a subframe of an uplink resource block, a subframe of an uplink resource block, and a subframe of a downlink resource block.

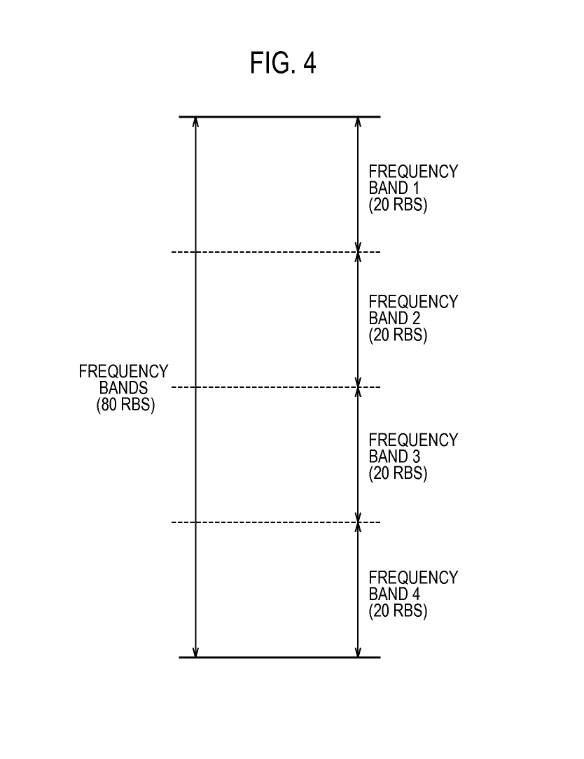

Furthermore, in the frequency direction, an available frequency band in radio communication between the radio base station eNB1-1 and the serving radio terminal UE2 has a band corresponding to a plurality of resource blocks. Furthermore, the number of frequency bands is divided into a multiple of four of the resource blocks. FIG. 4 is a diagram illustrating the configuration of the available frequency band in radio communication between the radio base station eNB1-1 and the serving radio terminal UE2. As illustrated in FIG. 4, the available frequency band in the radio communication between the radio base station eNB1-1 and the serving radio terminal UE2 has a band corresponding to 80 resource blocks. Furthermore, the frequency band is segmented into a large frequency band 1 to a large frequency band 4, wherein each of the large frequency band 1 to the large frequency band 4 has a band corresponding to 20 resource blocks. Furthermore, the frequency band may be segmented into frequency bands (a small frequency band 1 to a small frequency band 5), instead of any one of the large frequency bands, wherein each of the frequency bands has a band corresponding to four resource blocks.

The downlink resource block is configured by a control information channel (PDCCH: Physical Downlink Control CHannel) for downlink control information transmission and a shared data channel (PDSCH: Physical Downlink Shared CHannel) for downlink user data transmission, in the time direction.

On the other hand, in the uplink resource block, a control information channel (PUCCH: Physical Uplink Control CHannel) for uplink control information transmission is configured at both ends of the frequency band available in the uplink radio communication, and a shared data channel (PUSCH: Physical Uplink Shared CHannel) for uplink user data transmission is configured in the central part.

### (2) Configuration of Radio Base Station

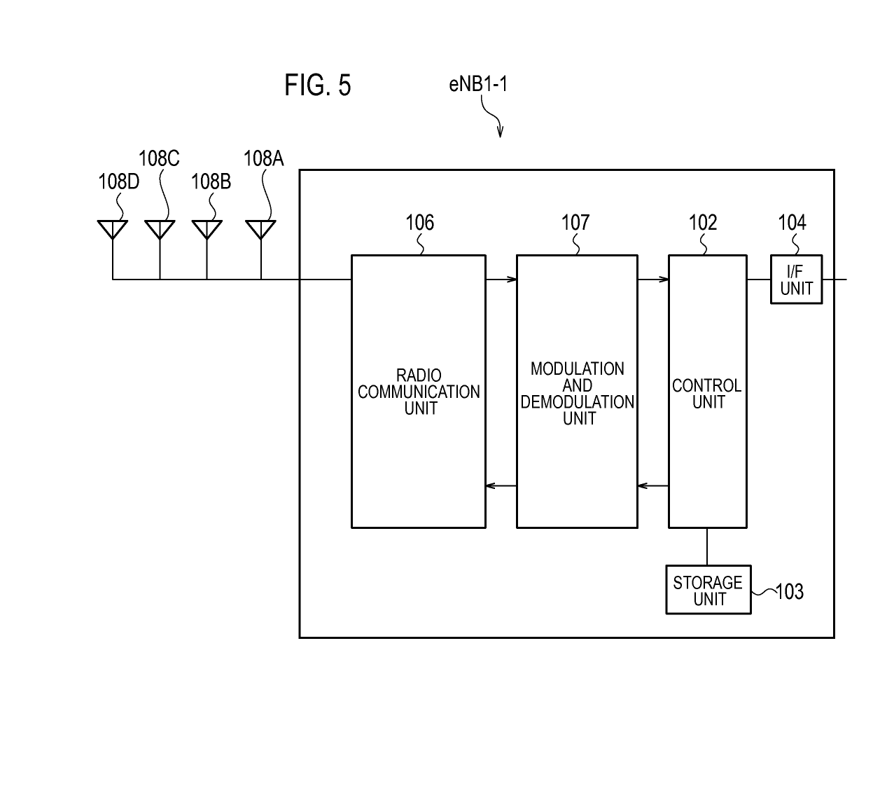

FIG. 5 is a configuration diagram of the radio base station eNB1-1. As illustrated in FIG. 5, the radio base station eNB1-1 is a radio base station of an adaptive array scheme, which applies an antenna weight to a plurality of antenna elements, and includes a control unit 102, a storage unit 103, an I/F unit 104, a radio communication unit 106, a modulation and demodulation unit 107, an antenna element 108A, an antenna element 108B, an antenna element 108C, and an antenna element 108D.

The control unit 102 is configured by, for example, a CPU, and controls various functions of the radio base station eNB1-1. The control unit 102 controls the serving radio terminal UE2 on the basis of a sounding reference signal (SRS) that is transmitted from the serving radio terminal UE2.

The storage unit 103 is configured by, for example, a memory, and stores various types of information used for the control and the like of the radio base station eNB1-1.

The I/F unit 104 is able to communicate with another radio base station eNB through an X1 interface. Furthermore, the I/F unit 104 is able to communicate with EPC (Evolved Packet Core, not illustrated), specifically, MME (Mobility Management Entity)/S-GW (Serving Gateway), through an S1 interface.

The radio communication unit 106 receives an uplink radio signal, which is transmitted from a serving radio terminal UE2-1, through the antenna element 108A to the antenna element 108D. Moreover, the radio communication unit 106 converts (down-converts) the received uplink radio signal to a baseband signal, and outputs the baseband signal to the modulation and demodulation unit 107.

The modulation and demodulation unit 107 performs demodulation and decoding processes for the input baseband signal. In this way, data included in the uplink radio signal transmitted from the radio terminal UE2-1 is obtained. The data is output to the control unit 102.

Furthermore, the modulation and demodulation unit 107 performs encoding and modulation of data from the control unit 102, thereby obtaining a baseband signal. The radio communication unit 106 converts (up-converts) the baseband signal to a downlink radio signal. Moreover, the modulation and demodulation unit 107 transmits a downlink radio signal through the antenna element 108A to the antenna element 108D.

Next, a detailed process of the control unit 102 will be described. The control unit 102 performs the following first process and second process.

(First Process)

The control unit 102 determines power that is required when the serving radio terminal UE2 existing in the cell 3-1 transmits SRS in a predetermined frequency bandwidth. The power (required SRS transmission power), which is required when the serving radio terminal UE2 transmits the SRS in the predetermined frequency bandwidth, is power with which the radio base station eNB1-1 is able to normally receive the SRS without a signal error, for example. The required SRS transmission power generally increases in proportion to a distance from the radio base station eNB1-1.

The control unit 102 sets segmentation (frequency band segmentation) in an available frequency band according to required SRS transmission power of each serving radio terminal UE2. Specifically, when there is a serving radio terminal UE2 having required SRS transmission power smaller than a predetermined value, the control unit 102 segments the available frequency band into a plurality of large frequency bands. Moreover, when there is a serving radio terminal UE2 having required SRS transmission power equal to or larger than a predetermined value, the control unit 102 segments the available frequency band into a plurality of small frequency bands, instead of any one of the large frequency bands.

Next, the control unit 102 arranges an SRS transmission frequency band in the available frequency band. Specifically, the control unit 102 arranges SRS transmission frequency band having a bandwidth of the large frequency band and a bandwidth of the small frequency band according to the frequency band segmentation that is set to the available frequency band.

Next, the control unit 102 sets an SRS transmission frequency band for each serving radio terminal UE2. Specifically, the control unit 102 sets an SRS transmission frequency band corresponding to the large frequency band for a serving radio terminal UE2 having required SRS transmission power smaller than a predetermined value. Furthermore, the control unit 102 sets an SRS transmission frequency band corresponding to the small frequency band for a serving radio terminal UE2 having required SRS transmission power equal to or more than the predetermined value.

Next, the control unit 102 transmits SRS transmission frequency band information to a serving radio terminal UE2 through the modulation and demodulation unit 107, the radio communication unit 106, and the antenna element 108A to the antenna element 108D. The SRS transmission frequency band information, for example, includes numerical values of an upper limit frequency and a lower limit frequency of a corresponding SRS transmission frequency band. When the serving radio terminal UE2 receives the SRS transmission frequency band information, the serving radio terminal UE2 transmits SRS by using a frequency band designated by the SRS transmission frequency band information at a timing of a special subframe.

At this time, the serving radio terminal UE2 transmits SRS while switching the SRS transmission frequency band at each timing of the special subframe by using a frequency hopping scheme.

In the present embodiment, a switching order in the frequency hopping scheme is common in each serving radio terminal UE2. In the present embodiment, as illustrated in FIG. 4, the frequency bands are switched in a periodic switching order as in the following order of: the large frequency band 1, the large frequency band 3, the large frequency band 2, and the large frequency band 4, and then this cycle returns to the large frequency band 1 again. However, there is a difference in the SRS transmission frequency bands of each serving radio terminal UE2 at the same timing. Accordingly, the SRS transmission frequency bands at the timing of the predetermined special subframe are set to be different for each serving radio terminal UE2, so that the SRS transmission frequency bands in each special subframe after the predetermined special subframe are different for each serving radio terminal UE2.

Furthermore, also in the small frequency band, the frequency hopping scheme is employed similarly to the large frequency band. Moreover, five small frequency bands are treated as one large frequency band, and the frequency hopping scheme is employed together with other large frequency bands.

Then, the control unit 102 assigns a downlink resource block of the same frequency band as that of SRS received most recently to a serving radio terminal UE2 that is a transmission source of the SRS received most recently. Moreover, the control unit 102 calculates an antenna weight for the assigned downlink resource block.

Meanwhile, when another neighboring radio base station eNB receives SRS, the other neighboring radio base station eNB (not illustrated) performs null steering, and calculates an antenna weight such that a null is directed toward a radio terminal UE2 (a serving radio terminal UE2 for the radio base station eNB1-1) that is a transmission source of the SRS.

(Second Process)

The second process is performed under a predetermined condition after the SRS transmission frequency band is set for the serving radio terminal UE2 by the first process. The second process is performed separately and independently for each of the large frequency band and the small frequency band.

The control unit 102 determines whether the number of serving radio terminals UE2 is larger than the number of SRS transmission frequency bands. In a case of performing a process for the large frequency band, the control unit 102 determines whether the number of serving radio terminals UE2 to which the SRS transmission frequency band corresponding to the large frequency band is set, is larger than the number of SRS transmission frequency bands having a bandwidth of the large frequency band. In a case of performing a process for the small frequency band, the control unit 102 determines whether the number of serving radio terminals UE2, to which an SRS transmission frequency band corresponding to the small frequency band is set, is larger than the number of SRS transmission frequency bands having a bandwidth of the small frequency band.

When the number of the serving radio terminals UE2 is larger than the number of the SRS transmission frequency bands, the control unit 102 compares PF (Proporational Fair) values of the serving radio terminals UE2 with one another. The PF value is an index indicating the state of radio communication by the serving radio terminal UE2. In a case of performing the process for the large frequency band, the control unit 102 compares PF values of the serving radio terminals UE2, to which the SRS transmission frequency band corresponding to the large frequency band is set, with one another. In a case of performing the process for the small frequency band, the control unit 102 compares PF values of the serving radio terminals UE2, to which the SRS transmission frequency band corresponding to the small frequency band is set, with one another.

Next, the control unit 102 selects serving radio terminals UE2 of which the number exceeds the number of the SRS transmission frequency bands, sequentially from a serving radio terminal UE2 having a minimum PF value, and transmits RRC Connection Reconfiguration, which is a message including information (transmission stop instruction information) instructing to stop transmitting SRS, to the selected serving radio terminals UE2. In this case, it is assumed that there is one serving radio terminal UE2 of which the number exceeds the number of the SRS transmission frequency bands. In a case of performing the process for the large frequency band, the control unit 102 transmits RRC Connection Reconfiguration including the transmission stop instruction information to the serving radio terminal UE2 having a minimum PF value from among the serving radio terminals UE2 to which the SRS transmission frequency band corresponding to the large frequency band is set. In a case of performing the process for the small frequency band, the control unit 102 transmits RRC Connection Reconfiguration including the transmission stop instruction information to the serving radio terminal UE2 having a minimum PF value from among the serving radio terminals UE2 to which the SRS transmission frequency band corresponding to the small frequency band is set.

When the serving radio terminal UE2 receives the RRC Connection Reconfiguration including the transmission stop instruction information, the serving radio terminal UE2 stops transmitting SRS.

Next, in each of the case in which the process for the large frequency band is performed and the case in which the process for the small frequency band is performed, the control unit 102 determines whether RRC Connection Reconfiguration Complete, which is a message including response information to a transmission stop instruction (transmission stop instruction response information), is received as a response from the serving radio terminal UE2 that is the transmission destination of the RRC Connection Reconfiguration including the transmission stop instruction information.

When the control unit 102 receives the RRC Connection Reconfiguration Complete, the control unit 102 transmits RRC Connection Reconfiguration, which is a message including the SRS transmission frequency band information, to a serving radio terminal (another serving radio terminal) UE2, which starts transmitting at least SRS, from among serving radio terminals UE2 other than a serving radio terminal UE2 serving as a transmission source of the RRC Connection Reconfiguration Complete, through the modulation and demodulation unit 107, the radio communication unit 106, and the antenna element 108A to the antenna element 108D. In a case of performing the process for the large frequency band, the control unit 102 transmits the RRC Connection Reconfiguration, which is a message including the SRS transmission frequency band information to each serving radio terminal UE2, to which the SRS transmission frequency band corresponding to the large frequency band is set, and the serving radio terminal (the other serving radio terminal) UE2, which starts transmitting at least SRS, from among the serving radio terminals UE2 other than the serving radio terminal UE2 serving as the transmission source of the RRC Connection Reconfiguration Complete. In a case of performing the process for the small frequency band, the control unit 102 transmits the RRC Connection Reconfiguration, which is a message including the SRS transmission frequency band information to each serving radio terminal UE2, to which the SRS transmission frequency band corresponding to the small frequency band is set, and the serving radio terminal (the other serving radio terminal) UE2, which starts transmitting at least SRS, from among the serving radio terminals UE2 other than the serving radio terminal UE2 serving as the transmission source of the RRC Connection Reconfiguration Complete.

Then, the control unit 102 compares PF values of the serving radio terminals UE2 with one another. In a case of performing the process for the large frequency band, the control unit 102 compares PF values of the serving radio terminals UE2, to which the SRS transmission frequency band corresponding to the large frequency band is set, with one another. In a case of performing the process for the small frequency band, the control unit 102 compares PF values of the serving radio terminals UE2, to which the SRS transmission frequency band corresponding to the small frequency band is set, with one another.

Next, in each of the case in which the process for the large frequency band is performed and the case in which the process for the small frequency band is performed, in a serving radio terminal UE2 that is selected at the time of comparing PF values last time and stopped transmitting SRS and a serving radio terminal UE2 that is selected at the time of comparing PF values this time and stops transmitting SRS, the control unit 102 determines whether the selected serving radio terminals UE2 are changed. Furthermore, at the time of comparing PF values last time and at the time of comparing PF values this time, the control unit 102 determines whether the serving radio terminal UE2 having a minimum PF value is replaced.

When the serving radio terminal UE2 having a minimum PF value is replaced with a serving radio terminal UE2 that transmits SRS, the control unit 102 transmits RRC Connection Reconfiguration, which is a message including the transmission stop instruction information, to a serving radio terminal UE2 having a new minimum PF value (the PF value at the time of comparison this time). In a case of performing the process for the large frequency band, the control unit 102 transmits RRC Connection Reconfiguration, which includes the transmission stop instruction information to a serving radio terminal UE2, which transmits SRS and has a minimum PF value at the time of comparison this time, from among the serving radio terminals UE2 to which the SRS transmission frequency band corresponding to the large frequency band is set. In a case of performing the process for the small frequency band, the control unit 102 transmits RRC Connection Reconfiguration, which includes the transmission stop instruction information to a serving radio terminal UE2, which transmits SRS and has a minimum PF value at the time of comparison this time, from among the serving radio terminals UE2 to which the SRS transmission frequency band corresponding to the small frequency band is set.

Next, the control unit 102 transmits RRC Connection Reconfiguration, which is a message including information (transmission restart instruction information) for instructing to restart transmitting SRS to a serving radio terminal UE2 that stops transmitting SRS and has the minimum original PF value (the PF value at the time of comparison last time). The transmission restart instruction information, for example, includes numerical values of an upper limit frequency and a lower limit frequency of a corresponding SRS transmission frequency band.

When the transmission restart instruction information is received, the serving radio terminal UE2 restarts transmitting the SRS by using a frequency band designated by the transmission restart instruction information at a timing of a special subframe.

Next, in each of the case in which the process for the large frequency band is performed and the case in which the process for the small frequency band is performed, the control unit 102 determines whether RRC Connection Reconfiguration Complete, which is a message including the transmission stop instruction response information, is received as a response from the serving radio terminal UE2 that is a transmission destination of the RRC Connection Reconfiguration including the transmission stop instruction information, and determines whether RRC Connection Reconfiguration Complete, which is a message including the transmission restart instruction response information, is received as a response from the serving radio terminal UE2 that is a transmission destination of the RRC Connection Reconfiguration including the transmission restart instruction information. When the RRC Connection Reconfiguration Complete including the transmission stop instruction response information and the RRC Connection Reconfiguration Complete including the transmission restart instruction response information are received, the control unit 102 ends a series of processes.

Then, similarly to the first process, the control unit 102 assigns a downlink resource block of the same frequency band as that of SRS received most recently to a serving radio terminal UE2 that is a transmission source of the SRS received most recently. Moreover, the control unit 102 calculates an antenna weight for the assigned downlink resource block.

Meanwhile, when another neighboring radio base station eNB receives SRS, the other neighboring radio base station eNB (not illustrated) performs null steering, and calculates an antenna weight such that a null is directed toward a radio terminal UE2 (a serving radio terminal UE2 for the radio base station eNB1-1) that is a transmission source of the SRS.

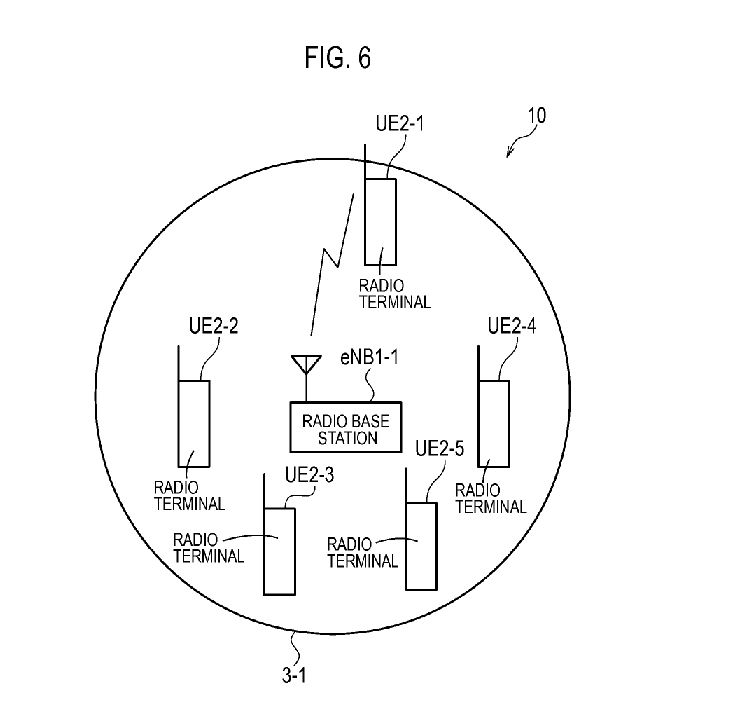

Hereinafter, an example of the second process will be described. As illustrated in FIG. 6, in the situation in which a serving radio terminal UE2-1 to a serving radio terminal UE2-4 already exist in the cell 3-1, the case, in which a serving radio terminal UE2-5 newly enters into the cell 3-1, is expected.

Furthermore, it is assumed that each of the serving radio terminal UE2-1 to the serving radio terminal UE2-5 has required SRS transmission power smaller than a predetermined value, and a transmittable frequency band is segmented into four large frequency bands.

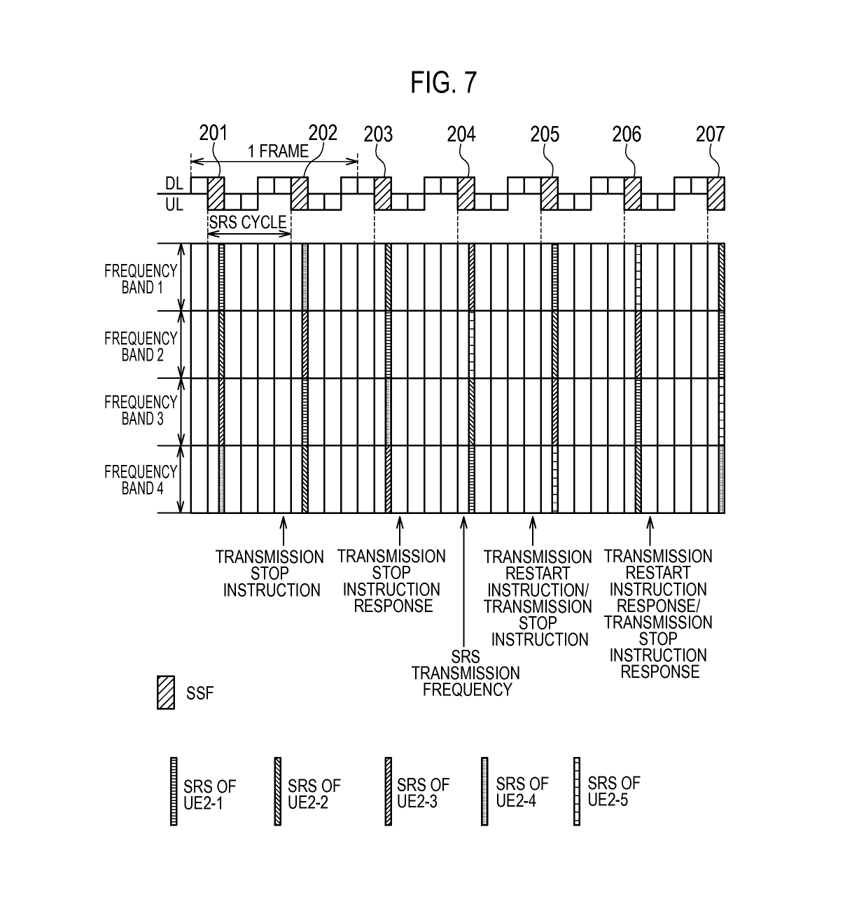

In this case, as illustrated in FIG. 7, initially, at a timing of a special subframe 201, each of the serving radio terminal UE2-1 to the serving radio terminal UE2-4 transmits SRS with a transmission frequency corresponding to a separate large frequency band. Then, when the serving radio terminal UE2-5 enters into the cell 3-1, the number of the serving radio terminals UE2 is larger than the number of the SRS transmission frequency bands by one. Therefore, the control unit 102 transmits RRC Connection Reconfiguration including transmission stop instruction information to a serving radio terminal UE2 (here, the serving radio terminal UE2-4) having the lowest PF value among the serving radio terminal UE2-1 to the serving radio terminal UE2-5. Then, at timings of a special subframe 202 and a special subframe 203, each of the serving radio terminal UE2-1 to the serving radio terminal UE2-4 transmits SRS by using the frequency hopping scheme while switching the SRS transmission frequency bands.

Then, when the control unit 102 transmits receives RRC Connection Reconfiguration Complete including the transmission stop instruction response information from the serving radio terminal UE2-4, the control unit 102 transmits SRS transmission frequency band information to the serving radio terminal UE2-5. Then, at a timing of a special subframe 204, the serving radio terminal UE2-5 starts transmitting SRS, and the serving radio terminal UE2-4 stops transmitting the SRS.

Moreover, when the serving radio terminal UE2 having the lowest PF value is replaced with one of the serving radio terminals UE2 that transmit SRS (here, when the serving radio terminal UE2-4 that stops transmitting SRS is replaced with the serving radio terminal UE2-3 that transmits SRS), the control unit 102 transmits RRC Connection Reconfiguration including the transmission restart instruction information to the serving radio terminal UE2-4 while transmitting RRC Connection Reconfiguration including the transmission stop instruction information to the serving radio terminal UE2-3. Then, at timings of the special subframe 205 and the special subframe 206, the serving radio terminal UE2-1 to the serving radio terminal UE2-3 and the serving radio terminal UE2-5 transmit SRS by using the frequency hopping scheme while switching the SRS transmission frequency bands.

Then, the control unit 102 receives RRC Connection Reconfiguration Complete including the transmission restart instruction response information from the serving radio terminal UE2-4, and receives RRC Connection Reconfiguration Complete including the transmission stop instruction response information from the serving radio terminal UE2-3. Then, at a timing of a special subframe 207, the serving radio terminal UE2-4 restarts transmitting SRS, and the serving radio terminal UE2-3 stops transmitting the SRS.

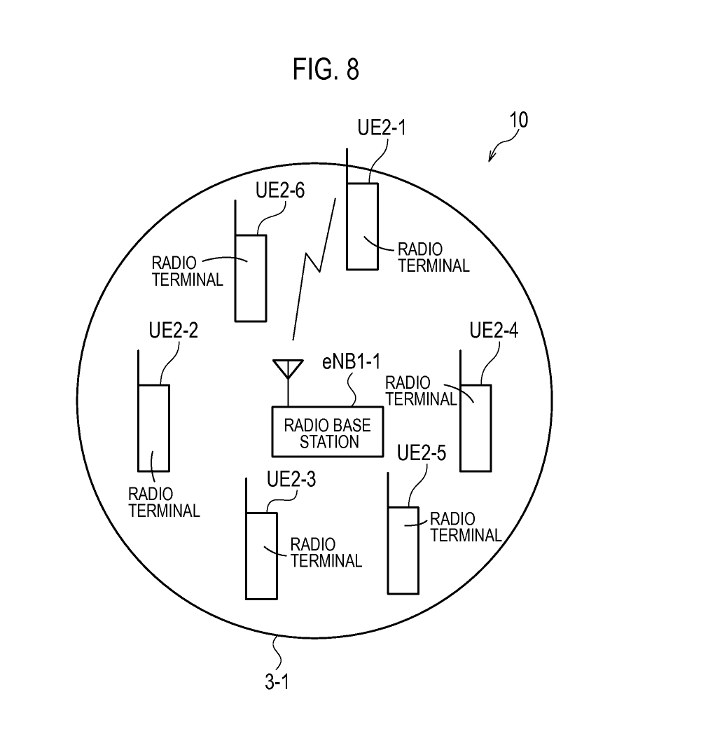

Furthermore, as illustrated in FIG. 8, in the situation in which the serving radio terminal UE2-1 to a serving radio terminal UE2-4 already exist in the cell 3-1, the case, in which the serving radio terminal UE2-5 and a serving radio terminal UE2-6 newly enter into the cell 3-1, is expected.

Furthermore, it is assumed that each of the serving radio terminal UE2-1 to the serving radio terminal UE2-3 and the serving radio terminal UE2-6 has required SRS transmission power smaller than a predetermined value, each of the serving radio terminal UE2-4 and the serving radio terminal UE2-5 has required SRS transmission power equal to or more than the predetermined value, and a transmittable frequency band is segmented into four large frequency bands and five small frequency bands.

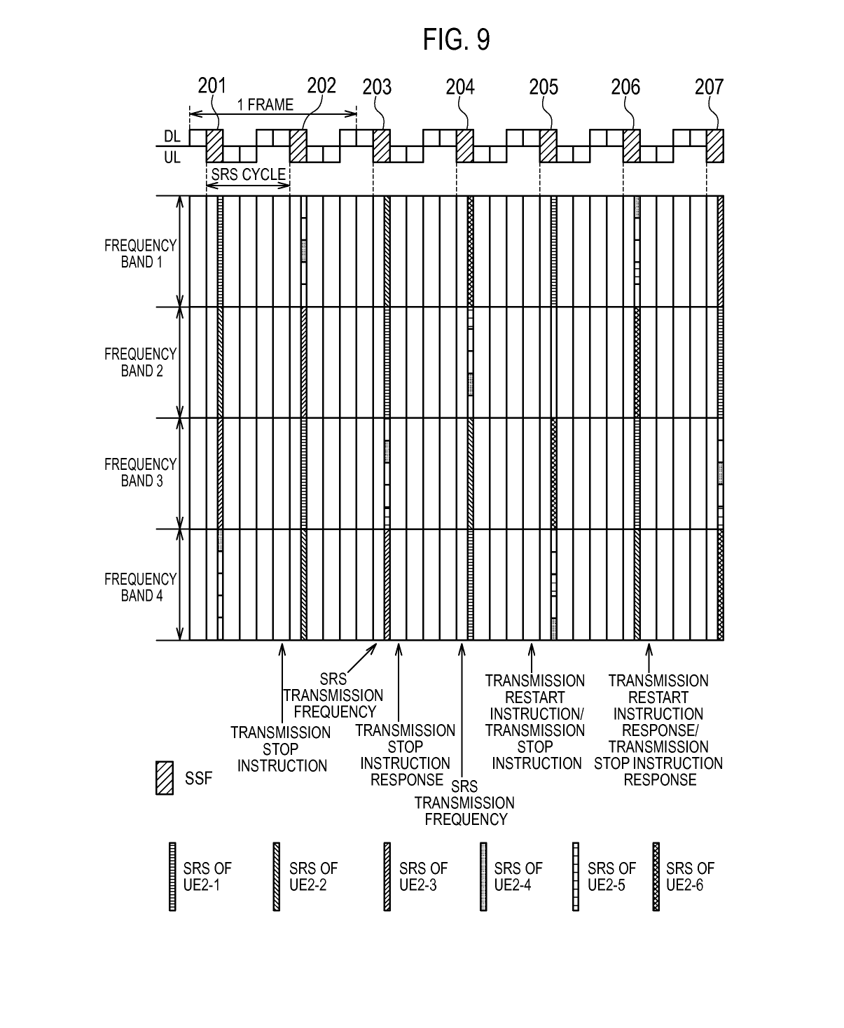

In this case, as illustrated in FIG. 9, initially, at a timing of the special subframe 201, each of the serving radio terminal UE2-1 to the serving radio terminal UE2-3 transmits SRS with a transmission frequency corresponding to a separate large frequency band, and the serving radio terminal UE2-4 transmits SRS with a transmission frequency corresponding to a small frequency band. Then, when the serving radio terminal UE2-5 and the serving radio terminal UE2-6 enter into the cell 3-1, the number of the serving radio terminals UE2 having required SRS transmission power smaller than the predetermined value is larger than the number of the SRS transmission frequency bands corresponding to the large frequency band by one. Therefore, the control unit 102 transmits RRC Connection Reconfiguration including the transmission stop instruction information to a serving radio terminal UE2 (here, the serving radio terminal UE2-3) having the lowest PF value among the serving radio terminal UE2-1 to the serving radio terminal UE2-3 and the serving radio terminal UE2-6. Meanwhile, the number of the serving radio terminals having required SRS transmission power equal to or more than the predetermined value is equal to or less than the number of the SRS transmission frequency bands corresponding to the small frequency band. Therefore, the control unit 102 transmits the SRS transmission frequency band information to the serving radio terminal UE2-5.

At timings of the special subframe 202 and the special subframe 203, each of the serving radio terminal UE2-1, the serving radio terminal UE2-2, and the serving radio terminal UE2-3 transmits SRS by using the frequency hopping scheme while switching the SRS transmission frequency bands corresponding to the large frequency band. Furthermore, at timings of the special subframes 202 to 207, the serving radio terminal UE2-4 having required SRS transmission power equal to or more than the predetermined value transmits SRS by using the frequency hopping scheme while switching the SRS transmission frequency bands corresponding to the small frequency band. Moreover, at a timing of the special subframe 203, the serving radio terminal UE2-5 having required SRS transmission power equal to or more than the predetermined value starts transmitting SRS, and at timings of special subframe 204 to 207, the serving radio terminal UE2-6 having required SRS transmission power smaller than the predetermined value transmits SRS by using the frequency hopping scheme while switching the SRS transmission frequency bands corresponding to the large frequency band.

Then, when the control unit 102 receives RRC Connection Reconfiguration Complete including the transmission stop instruction response information from the serving radio terminal UE2-3, the control unit 102 transmits the SRS transmission frequency band information to the serving radio terminal UE2-6. Then, at a timing of the special subframe 204, the serving radio terminal UE2-6 starts transmitting SRS, and the serving radio terminal UE2-3 stops transmitting the SRS.

Moreover, when the serving radio terminal UE2 having the lowest PF value is replaced with one of the serving radio terminals UE2 that transmit SRS (here, when the serving radio terminal UE2-3 that stops transmitting SRS is replaced with the serving radio terminal UE2-2 that transmits SRS), the control unit 102 transmits RRC Connection Reconfiguration including the transmission restart instruction information to the serving radio terminal UE2-3 while transmitting RRC Connection Reconfiguration including the transmission stop instruction information to the serving radio terminal UE2-2.

Then, the control unit 102 receives RRC Connection Reconfiguration Complete including the transmission restart instruction response information from the serving radio terminal UE2-3, and receives RRC Connection Reconfiguration Complete including the transmission stop instruction response information from the serving radio terminal UE2-2. Then, at a timing of the special subframe 207, the serving radio terminal UE2-3 restarts transmitting SRS, and the serving radio terminal UE2-2 stops transmitting the SRS.

### (3) Operation of Radio Base Station

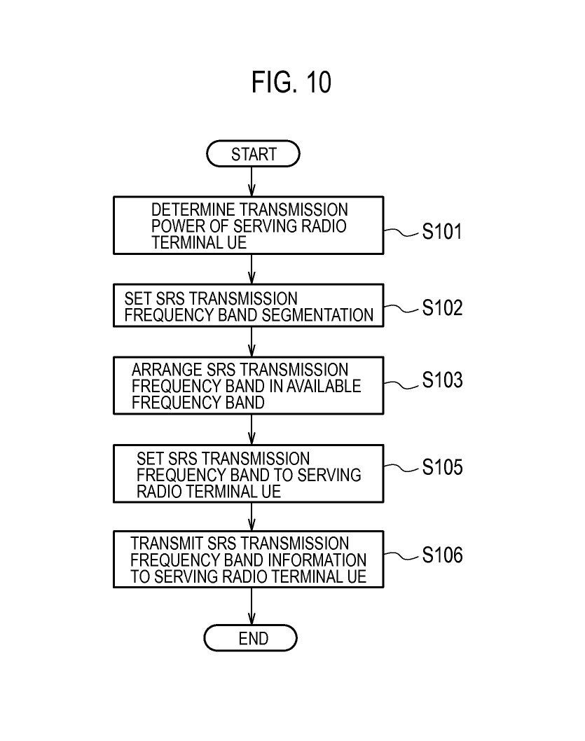

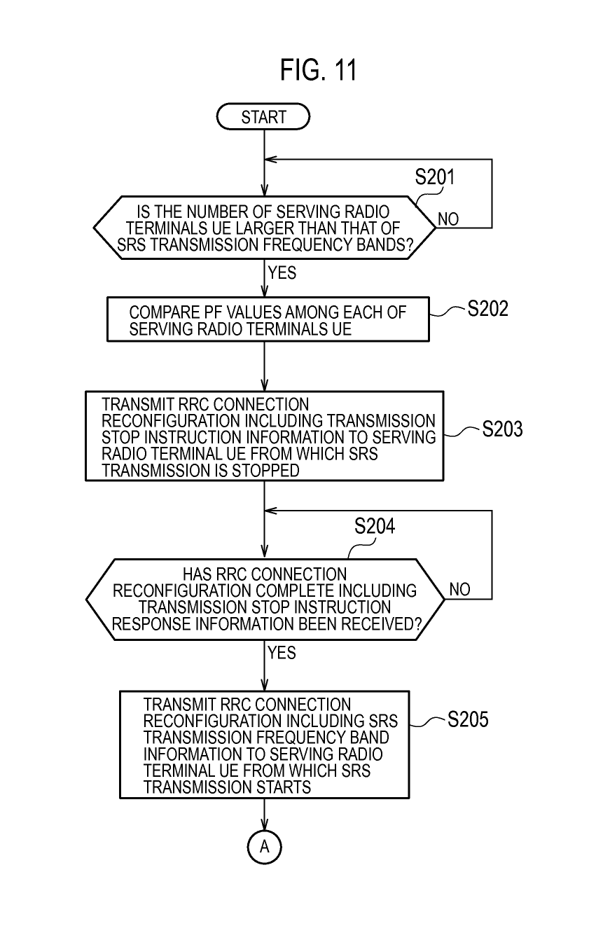

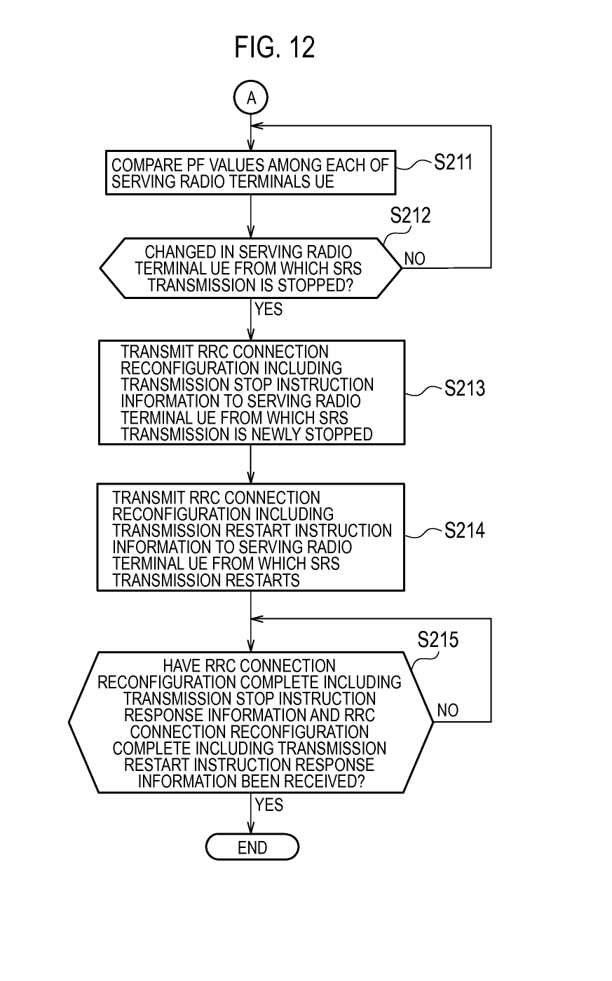

FIG. 10 to FIG. 12 are flowcharts illustrating the operation of the radio base station eNB1-1. FIG. 10 corresponds to the aforementioned first process and FIG. 11 and FIG. 12 correspond to the aforementioned second process.

In step S101 of FIG. 10, the control unit 102 determines power (required SRS transmission power) that is required when the serving radio terminal UE2 existing in the cell 3-1 transmits SRS in a predetermined frequency bandwidth.

In step S102, the control unit 102 sets segmentation (frequency band segmentation) in an available frequency band according to the required SRS transmission power of each serving radio terminal UE2.

In step S103, the control unit 102 arranges SRS transmission frequency bands in the available frequency band.

In step S104, the control unit 102 arranges SRS transmission frequency bands having a bandwidth of the large frequency band and a bandwidth of the small frequency band according to the frequency band segmentation that is set to the available frequency band.

In step S105, the control unit 102 sets the SRS transmission frequency bands for each serving radio terminal UE2.

In step S201 of FIG. 11, the control unit 102 determines whether the number of the serving radio terminals UE2 is larger than the number of the SRS transmission frequency bands.

When the number of serving radio terminals UE2 is larger than the number of the SRS transmission frequency bands, the control unit 102 compares PF values of the serving radio terminals UE2 with one another in step S202.

In step S203, the control unit 102 selects serving radio terminals UE2 of which the number exceeds the number of the SRS transmission frequency bands, sequentially from the serving radio terminal UE2 having a minimum PF value, and transmits RRC Connection Reconfiguration, which is a message including the information (the transmission stop instruction information) instructing to stop transmitting SRS, to the selected serving radio terminals UE2. It is noted that in this case, it is assumed that as a result of the determination, the number of the serving radio terminals UE2 is larger than the number of the SRS transmission frequency bands by one, and the RRC Connection Reconfiguration, which is a message including the information (the transmission stop instruction information) instructing to stop transmitting the SRS, is transmitted to the serving radio terminal UE2 having a minimum PF value.

In step S204, the control unit 102 determines whether RRC Connection Reconfiguration Complete, which is a message including response information to a transmission stop instruction (the transmission stop instruction response information), is received as a response from the serving radio terminal UE2 that is a transmission destination of the RRC Connection Reconfiguration including the transmission stop instruction information.

When the control unit 102 receives the RRC Connection Reconfiguration Complete, the control unit 102 transmits RRC Connection Reconfiguration, which is a message including the SRS transmission frequency band information, to a serving radio terminal (another serving radio terminal) UE2, which starts transmitting at least SRS, from among serving radio terminals UE2 other than a serving radio terminal UE2 serving as a transmission source of the RRC Connection Reconfiguration Complete, in step S205.

In step S211 of FIG. 12, the control unit 102 compares PF values of the serving radio terminals UE2.

In step S212, in a serving radio terminal UE2 that is selected at the time of comparing PF values last time and stopped transmitting SRS and a serving radio terminal UE2 that is selected at the time of comparing PF values this time and stops transmitting SRS, the control unit 102 determines whether the selected serving radio terminals UE2 are changed, and determines whether the serving radio terminal UE2 having a minimum PF value is replaced.

When the serving radio terminal UE2 having a minimum PF value is replaced with one of the serving radio terminals UE2 that transmit SRS, the control unit 102 transmits RRC Connection Reconfiguration, which is a message including the transmission stop instruction information, to a serving radio terminal UE2 that newly stops transmitting SRS and has a new minimum PF value (the PF value at the time of comparison this time) during the transmission of the SRS, in step S213.

In step S214, the control unit 102 transmits RRC Connection Reconfiguration, which is a message including the information (the transmission restart instruction information) for instructing to restart transmitting SRS to a serving radio terminal UE2 that restarts transmitting SRS and has the minimum original PF value (the PF value at the time of comparison last time).

In step S215, the control unit 102 determines whether RRC Connection Reconfiguration Complete, which is a message including the transmission stop instruction response information, is received as a response from the serving radio terminal UE2 that is a transmission destination of the RRC Connection Reconfiguration including the transmission stop instruction information, and determines whether RRC Connection Reconfiguration Complete, which is a message including the transmission restart instruction response information, is received as a response from the serving radio terminal UE2 that is a transmission destination of the RRC Connection Reconfiguration including the transmission restart instruction information. When the RRC Connection Reconfiguration Complete including the transmission stop instruction response information and the RRC Connection Reconfiguration Complete including the transmission restart instruction response information have been received, the control unit 102 ends a series of operations.

### (4) Operation and Effect

In the present embodiment, when the number of the serving radio terminals UE2 in the cell 3-1 is larger than the number of the SRS transmission frequency bands that are set to the transmittable frequency band, the radio base station eNB1-1 transmits RRC Connection Reconfiguration, which includes the information (the transmission stop instruction information) instructing to stop transmitting SRS, to a serving radio terminal UE2 that is regarded as having a small PF value and a low priority of SRS transmission.

Consequently, the number of the serving radio terminals UE2 that transmit SRS is equal to or less than the number of the SRS transmission frequency bands that are set to the transmittable frequency band, so that SRS is prevented from overlapping in the same frequency band at the same timing. Thus, another neighboring radio base station eNB is able to uniquely determine an SRS transmission source, thereby enabling appropriate null steering.

Furthermore, after transmitting the transmission stop instruction information, when there is a serving radio terminal (a second serving radio terminal) UE2 that is regarded as having a smaller PF value and a lower priority of SRS transmission, as compared with a serving radio terminal (a first serving radio terminal) UE2 that is a transmission destination of the transmission stop instruction information, the radio base station eNB1-1 transmits RRC Connection Reconfiguration, which includes the information (the transmission restart instruction information) instructing to restart transmitting SRS, to the first serving radio terminal.

Consequently, the radio base station eNB1-1 is able to appropriately select a serving radio terminal UE2 that should stop transmitting the SRS, in response to a change in the PF value, in other words, a change in a communication state.

Furthermore, the radio base station eNB1-1 receives RRC Connection Reconfiguration Complete including the response information (the transmission stop instruction response information) indicating that the transmission stop instruction information is received from the serving radio terminal UE2 that is a transmission destination of the transmission stop instruction information.

Consequently, the radio base station eNB1-1 is able to recognize that the serving radio terminal UE2 apparently received the transmission stop instruction information. Thus, after receiving the transmission stop instruction response information, the radio base station eNB1-1 transmits the SRS transmission frequency band information to a serving radio terminal UE2 other than the transmission destination of the transmission stop instruction response information, so that SRS is surely prevented from overlapping in the same frequency band at the same timing.

Furthermore, according to the required SRS transmission power associated with a bandwidth of the SRS transmission frequency band in the serving radio terminal UE2, the radio base station eNB1-1 arranges the large frequency band and the small frequency band in the available frequency band.

Consequently, the radio base station eNB1-1 is able to arrange the SRS transmission frequency band corresponding to the large frequency band and the SRS transmission frequency band corresponding to the small frequency band at positions, where the available frequency bands are different from one another, at a predetermined timing. Through such control, SRS is prevented from overlapping in the same frequency band at the same timing. Thus, another neighboring radio base station is able to uniquely determine an SRS transmission source, thereby enabling appropriate null steering.

### (5) Other Embodiments

As mentioned above, the present invention was described according to the embodiment. It must not be understood that the discussions and the drawings constituting a part of this disclosure limit the present invention. From this disclosure, various alternative embodiment, examples and operational technique are apparent to those skilled in the art.

In the aforementioned embodiment, the control unit 102 segmented the transmittable frequency band into the large frequency band and the small frequency band. However, the control unit 102 may segment the transmittable frequency band into frequency bands having three or more types of bandwidths.

For example, when there are a serving radio terminal UE2 having required SRS transmission power equal to or more than a first predetermined value, a serving radio terminal UE2 having required SRS transmission power smaller than the first predetermined value and equal to or more than a second predetermined value, and a serving radio terminal UE2 having required SRS transmission power smaller than the second predetermined value, the control unit 102 segments the available frequency band into the large frequency band, a medium frequency band, and the small frequency band.

Moreover, the control unit 102 arranges SRS transmission frequency bands having a bandwidth of the large frequency band, a bandwidth of the medium frequency band, and a bandwidth of the small frequency band according to the frequency band segmentation that is set to the available frequency band.

Next, the control unit 102 sets the SRS transmission frequency band corresponding to the large frequency band in the serving radio terminal UE2 having required SRS transmission power smaller than the second predetermined value. The control unit 102 sets the SRS transmission frequency band corresponding to the medium frequency band in the serving radio terminal UE2 having required SRS transmission power smaller than the first predetermined value and equal to or more than the second predetermined value. The control unit 102 sets the SRS transmission frequency band corresponding to the small frequency band in the serving radio terminal UE2 having required SRS transmission power equal to or more than the first predetermined value.

Furthermore, in the aforementioned embodiment, since the number of the serving radio terminals UE2 exceeding the number of the SRS transmission frequency bands was one, the control unit 102 selected the serving radio terminal UE2 having the lowest PF value as a serving radio terminal UE2 that should stop transmitting the SRS. However, when the number of the serving radio terminals UE2 exceeding the number of the SRS transmission frequency bands is plural, the control unit 102 may select the excess of serving radio terminals UE2 as the serving radio terminal UE2 that should stop transmitting the SRS.

For example, when the number of serving radio terminals UE2 is larger than the number of the SRS transmission frequency bands by three, the control unit 102 selects serving radio terminals UE2 having three lowest PF values as the serving radio terminals UE2 that should stop transmitting the SRS. Moreover, the control unit 102 transmits RRC Connection Reconfiguration including the transmission stop instruction information to the selected three serving radio terminals UE2.

Then, when any one of the serving radio terminal UE is replaced from among the serving radio terminals UE having three lowest PF values, the control unit 102 transmits RRC Connection Reconfiguration including the transmission stop instruction information to serving radio terminals UE2 newly having the three lowest PF values, and transmits RRC Connection Reconfiguration including the transmission restart instruction information to a serving radio terminal UE2 having no the three lowest PF values.

Furthermore, in the aforementioned embodiment, on the basis of the PF value, the control unit 102 selected the serving radio terminal UE2 that should stop transmitting the SRS. However, on the basis of another index indicating a communication state of a serving radio terminal UE2, the control unit 102 may select a serving radio terminal UE2 having a low index as the serving radio terminal UE2 that should stop transmitting the SRS. Furthermore, by using a round-robin scheme, the control unit 102 may sequentially select each serving radio terminal UE2 as the serving radio terminal UE2 that should stop transmitting the SRS.

In the aforementioned embodiments, the TDD-LTE radio communication system was described. However, the present invention can be applied in the same manner to all types of radio communication systems employing asymmetric radio communication in which a frequency band of an uplink radio signal to be assigned to a radio terminal is different from a frequency band of a downlink radio signal.

As mentioned above, it must be understood that the present invention includes various embodiments and the like that are not described herein.

Note that the entire contents of the Japanese Patent Application Nos. 2011-040350 (filed on Feb. 25, 2011) and 2011-040354 (filed on Feb. 25, 2011) are incorporated herein by reference.

### INDUSTRIAL APPLICABILITY

As mentioned above, the radio base station and the communication control method according to the present invention is useful in radio communication, which allow a neighboring radio base station to perform appropriate null steering.

1. A radio base station, which controls radio terminals on the basis of a reference signal from the radio terminals, comprising:
a control unit that transmits information instructing to stop transmitting the reference signal to a first radio terminal, which is regarded as having a low priority of transmission of the reference signal, when the number of the radio terminals is larger than the number of transmission frequency bands of the reference signal.

2. The radio base station according to claim 1, wherein, when there is a second radio terminal, which is regarded as having a lower priority of transmission of the reference signal as compared with the first radio terminal, the control unit transmits information instructing to restart transmitting the reference signal to the first radio terminal.

3. The radio base station according to claim 1, comprising: a reception unit that receives, from the first radio terminal, response information which indicates reception of information for instructing to stop transmitting the reference signal.

4. The radio base station according to claim 1, wherein, on the basis of an index indicating a state of radio communication by the radio terminals, the control unit selects the first radio terminal having the lowest index.

5. The radio base station according to claim 1, wherein the control unit selects the first radio terminal on the basis of an index of a PF (Proportional Fair) scheme of each radio terminal.

6. The radio base station according to claim 1, wherein the control unit selects the first radio terminal by a round-robin scheme.

7. A communication control method in a radio base station, which controls radio terminals on the basis of a reference signal from the radio terminals, comprising:
a step of transmitting information instructing to stop transmitting the reference signal to a first radio terminal, which is regarded as having a low priority of transmission of the reference signal, when the number of the radio terminals is larger than the number of transmission frequency bands of the reference signal.

8. A radio base station, which controls radio terminals on the basis of a reference signal from the radio terminals, comprising:
a control unit that arranges transmission frequency bands of the reference signal in an available frequency band, wherein
the control unit arranges the transmission frequency bands of the reference signal according to bandwidths of the transmission frequency bands of the reference signal in the radio terminals.

9. The radio base station according to claim 8, wherein the control unit performs arrangement in the available frequency band for each group of the transmission frequency bands of the reference signal having the same bandwidth.

10. The radio base station according to claim 9, wherein the control unit arranges the transmission frequency bands of the reference signal, which belong to different groups, at different positions in the available frequency band.

11. A communication control method in a radio base station, which controls radio terminals on the basis of a reference signal from the radio terminals, comprising:
a control step of arranging, by the radio base station, transmission frequency bands of the reference signal in an available frequency band, wherein
in the control step, the radio base station arranges the transmission frequency bands of the reference signal according to bandwidths of the transmission frequency bands of the reference signal in the radio terminals.
